(19) United States
(12) Patent Application Publication
(10) Pub. No.: US 2016/0368557 A1
(43) Pub. Date: Dec. 22, 2016

(54) ELECTRONIC DEVICE CADDY

(71) Applicant: Delta Cycle Corporation, Randolph, MA (US)

(72) Inventors: Michael Downes, Coronado, CA (US); Errol Drew, Los Gatos, CA (US)

(73) Assignee: Delta Cycle Corporation

(21) Appl. No.: 15/249,621

(22) Filed: Aug. 29, 2016

Related U.S. Application Data
(63) Continuation-in-part of application No. 14/224,323, filed on Mar. 25, 2014.

(51) Int. Cl. B62J 9/00; H04B 1/3877; F16M 11/04; G10K 11/08; F16M 13/00; F16M 13/02

(52) U.S. Cl. CPC B62J 9/005; F16M 13/00; F16M 13/02; F16M 11/041; G10K 11/08; H04B 1/3877; F16M 2200/022; H04M 1/04

(57) ABSTRACT

An electronic device caddy includes a first tray portion an end cage and a second tray portion also including an end cage. A passive sound amplifier is associated with one end cage. A locking mechanism is also featured. A mounting bracket is attached rearward of one tray portion.

### RELATED APPLICATIONS

This application is a continuation-in-part of U.S. patent application Ser. No. 14/224,323 filed on Mar. 25, 2014 and claims the benefit of and priority thereto under 35 U.S.C. §§119, 120, 363, 365, and 37 C.F.R. §1.55 and §1.78. and which is incorporated herein by this reference.

### FIELD OF THE INVENTION

The subject invention relates to an electronic device caddy.

### BACKGROUND OF THE INVENTION

There are a variety of electronic device (e.g., cell phone) caddies. Such caddies may mount to the handle bars of a bicycle. See for example, published U.S. Patent Applications Nos. 2002/0113185 and 2005/0045681.

Various means are used to retain the electronic device in the caddy, some complex. In the applicant's prior caddy, a bungee cord biases two caddy tray portions about the electronic device securing the electronic device in the caddy. See the Delta Cycle Corp. “Smartphone Mount for Bikes” product. Sometimes, however, the cell phone was still ejected from the caddy during rough riding conditions.

### SUMMARY OF THE INVENTION

In one example of the invention, a new caddy is provided which more securely retains an electronic device and yet is easy to use and enables the electronic device to be quickly and easily loaded into and removed from the caddy. The caddy also includes a passive sound amplifier.

Featured is an electronic device caddy comprising a first tray portion with, for example, two spaced lengthwise channels and an end cage and a second tray portion also including an end cage and two lengthwise rails slideable in the spaced channels of the first tray portion to load and accommodate different size electronic devices between the end cages. A locking mechanism releaseably locks at least one rail in its channel A mounting bracket is attached rearward of one tray portion.

In one version, the locking mechanism includes a cam surface. The rail may include a rearward ear extending out of the channel and the locking mechanism may include a cam surface ferrule, a slot in the ferrule receiving the ear, and a lever attached to the ferrule. Preferably, the cam surface engages the first tray portion frictionally urging the rail against an inside surface of the channel when the ferrule cam surface is rotated. The channel may include a lengthwise rearward slot, the rail may include a lengthwise rearward ridge extending through the slot, and the ear may extend rearwardly from the ridge.

In some designs, the channels terminate proximate the end cage of the first tray portion. The mounting bracket may be configured as a handle bar mount. There may be one or more bungees urging the tray portions together. In one example, a bungee extends from one cage to the other cage.

Also featured is an electronic device caddy comprising an upper tray portion with an upper end cage and a lower tray portion including a lower end cage configured to load and accommodate different size electronic devices between the end cages. Preferably, the passive sound amplifier is a cup shaped member located at the right side of the lower end cage and extending outwardly from the lower tray portion.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features, and advantages will occur to those skilled in the art from the following description of a preferred embodiment and the accompanying drawings, in which:

FIG. 1 is a schematic front view of an electronic device caddy in accordance with an example of the invention;

FIG. 2 is a schematic rear view of the caddy shown in FIG. 1;

FIG. 3 is another schematic rear view of the caddy shown in FIGS. 1 and 2;

FIG. 4 is a schematic rear view showing the locking mechanism locked down;

FIG. 5 is a schematic cross-sectional view of an example of a locking mechanism urging a caddy tray portion rail against an inside surface of the other tray portion channel;

FIG. 6 is a schematic end view showing one tray portion rail inside another tray portion channel and various aspects of the locking mechanism of FIG. 5;

FIG. 7 is a schematic front view showing a cell phone securely retained in an example of a caddy in accordance with the invention;

FIG. 8 is a schematic view showing the front lower portion of an example of a caddy with a passive sound amplifier;

FIG. 9 is a schematic view showing the bottom of the caddy of FIG. 8; and

FIG. 10 is a schematic view showing the rearward bottom side of the caddy of FIGS. 8 and 9.

### DETAILED DESCRIPTION OF THE INVENTION

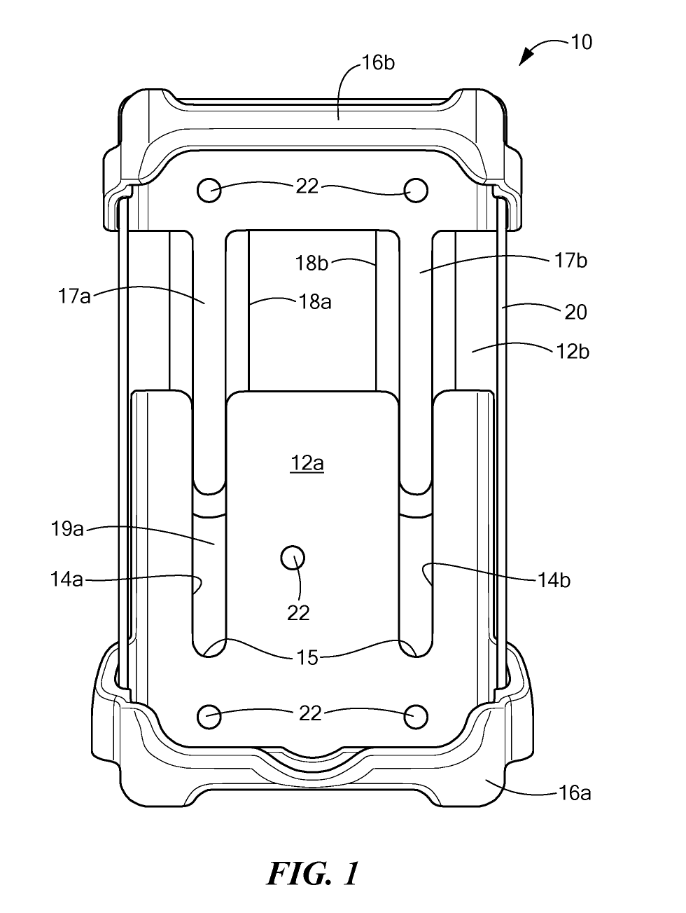

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer. In one preferred example, electronic device caddy 10, FIG. 1 includes first tray portion 12a with one or more spaced lengthwise channels 14a and 14b and end cage 16a. Second try portion 12b includes end cage 16b and one or more lengthwise rails 18a and 18b. Rails 18a and 18b are slideably received channels 14a and 14b and thus end cage 16a can be slid towards and away from cage 16b to load and accommodate different size electronic devices. Channels 14a and 14b terminate as shown at 15 near cage 16a and each rail may include a top ridge 17a accommodated by top slot 19a in the top wall of channel 14a. The rails are typically tongue-like members, fairly flat and thin, slideably received in their respective channels between inside upper and lower channel surfaces.

The width and depth of the end cages can vary to provide caddies for different size electronic devices (e.g., cellular telephones, GPS units, tablets, mini-tablets, e-book readers, and the like).

Bungee cord 20 is typically provided to bias the two tray portions 12a, 12b closed to assist in retaining an electronic device in the caddy when inserted into end cages 16a and 16b. In this particular example, bungee cord 20 runs from the right hand side of case 16a up to and through the right hand side of cage 16b, over the top of cage 16b, back through the left hand side of cage 16b and down to a termination point at cage 16a. Elastic bumpers 22 can be placed on the front face of the tray portions as shown to cushion the rear of the electronic device.

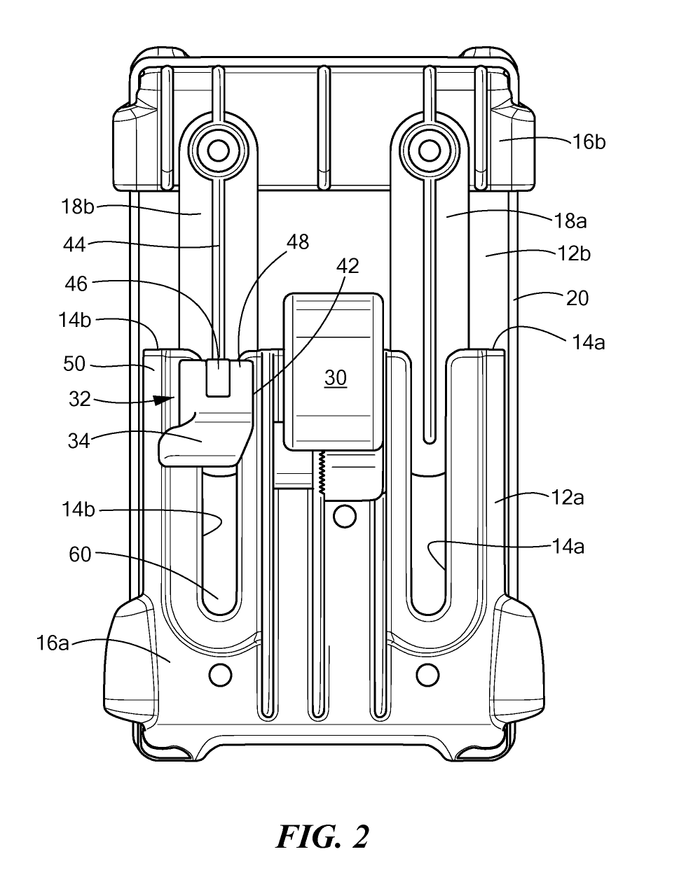

FIG. 2 shows the rear of the caddy where mounting bracket 30 is used to secure the caddy to, for example, the handle bars of a bicycle, four-wheeler, or the like. Other mounting brackets can be used such as such as a mounting bracket configured to be secured to the stem of a bicycle handle bar.

Also shown is locking mechanism 32 which releaseably locks rail 18b in channel 14b to more securely retain an electronic device in the caddy during rough conditions such as extreme mountain biking. Locking mechanism 32 is secured to the rail and moves with it as the tray portions are adjusted.

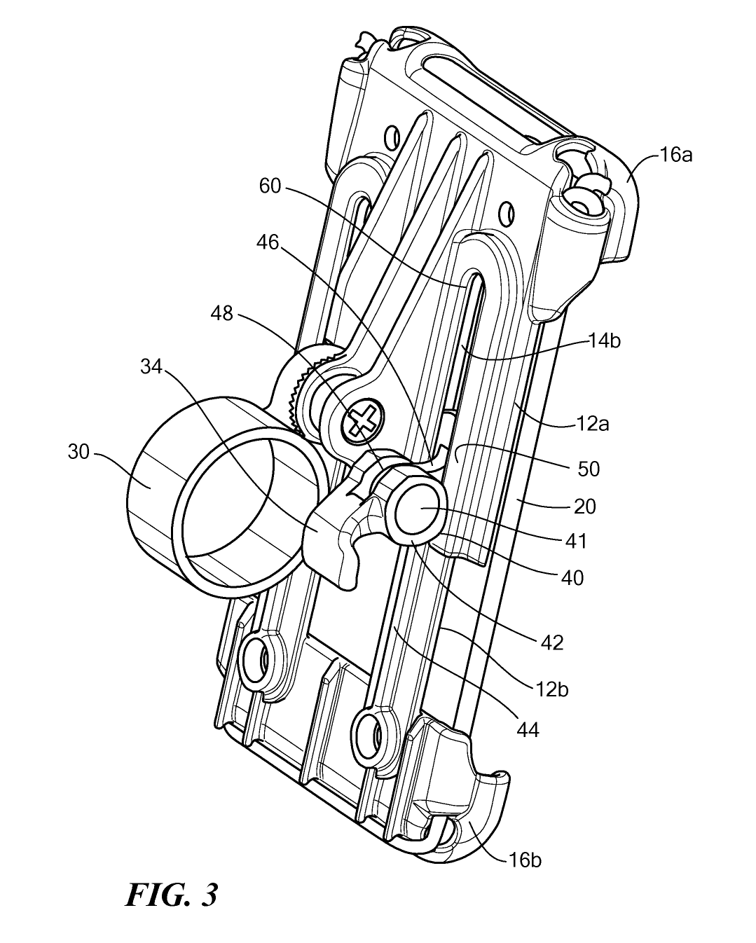

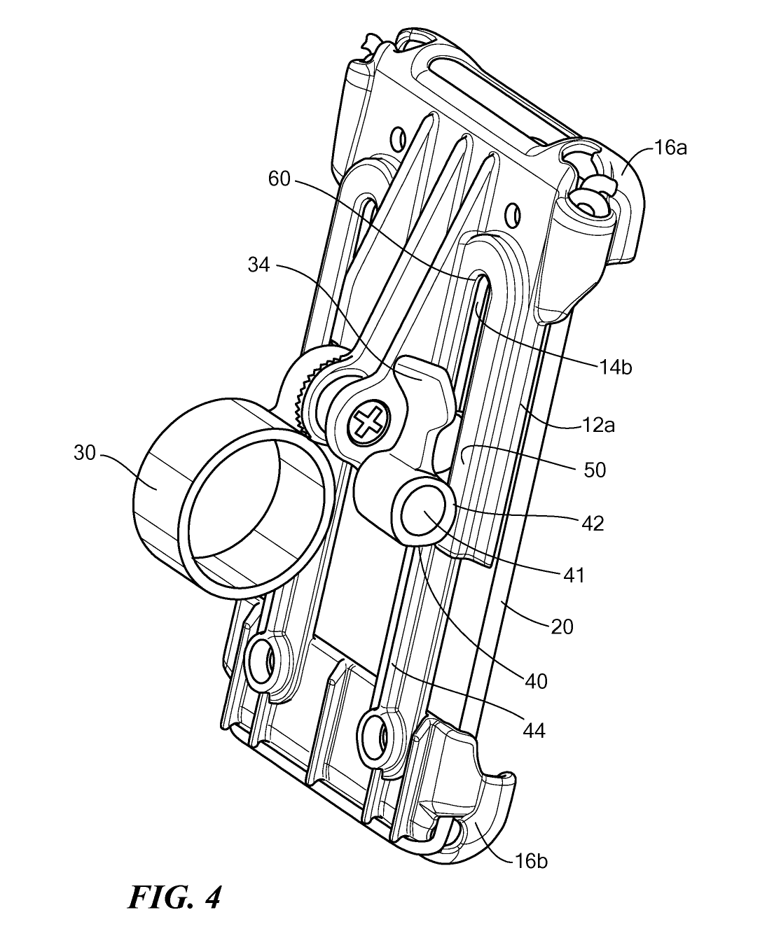

In FIG. 3, the locking mechanism is unlocked and the end cage 16b can be moved away from end cage 16a by overcoming the spring force of bungee 20 to insert an electronic device into the caddy. Upon release, the bungee urges the end cages together and the electronic device is now fairly secure in the caddy. In FIG. 4, the locking mechanism is locked by simply pushing lever 34 down. This action locks rail 18b in channel 14b to more securely retain an electronic device in the caddy.

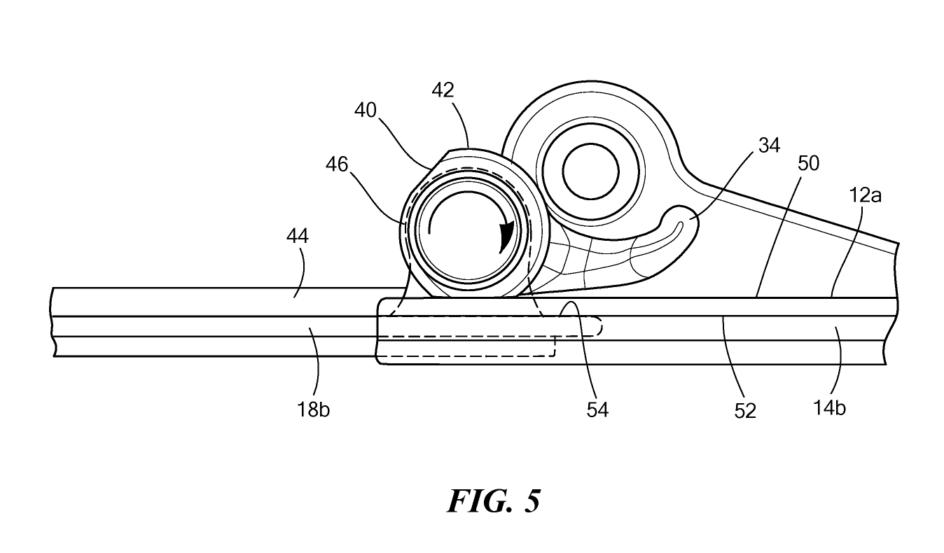

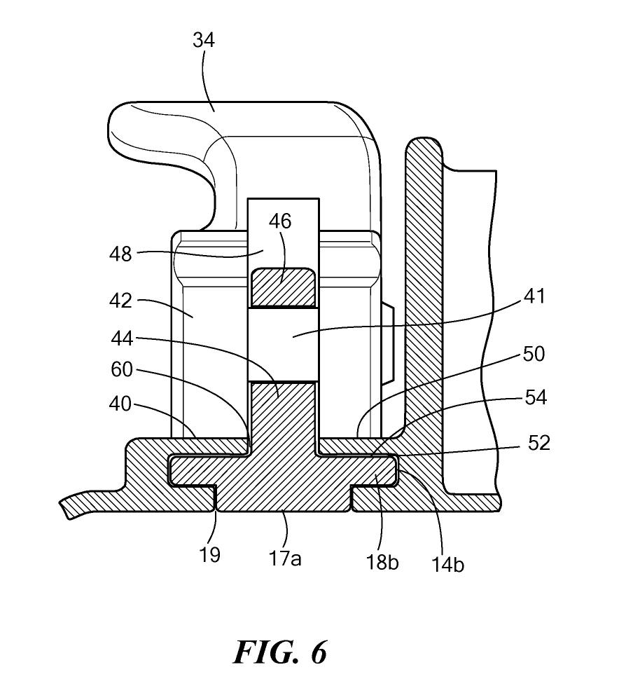

In this preferred embodiment, the locking mechanism includes cam surface 40 on the exterior of ferrule 42 pivotally mounted to bottom ridge 44 of rail 18b via ear 46 extending rearwardly from ridge 44 out of channel 14b. Ear 46 is pivotally received in slot 48 of ferrule 42. When rotated, the cam surface 40 engages tray 12 a rear surface 50 over channel 14b. A fastener 41 extends through the ferrule and ear. In this way, when lever 34 is moved down as shown in FIGS. 5-6 cam surface 40 (shown exaggerated) moves against rear surface 50 of the tray portion driving the ridge 44 rearward and pulling rail 18b into engagement with the inside bottom surface 52 of channel 14b so the rail bottom surface 54 is forced to maintain tight contact with the inside bottom surface 52 of channel 14b frictionally locking the rail in the channel to more securely retain the electronic device in the caddy.

To accommodate bottom rail ridge 44, FIGS. 2-6, channel 14b includes rear side slot 60. There may be a similar locking mechanism for rail 18a, FIG. 2. Other means for releasably and adjustably locking one or more rails in their respective slots may also be used. One example would be a locking mechanism which pushes the top of the rail to engage a top inside surface of the channel or which drives an edge of the rail against an inside side surface of the channel.

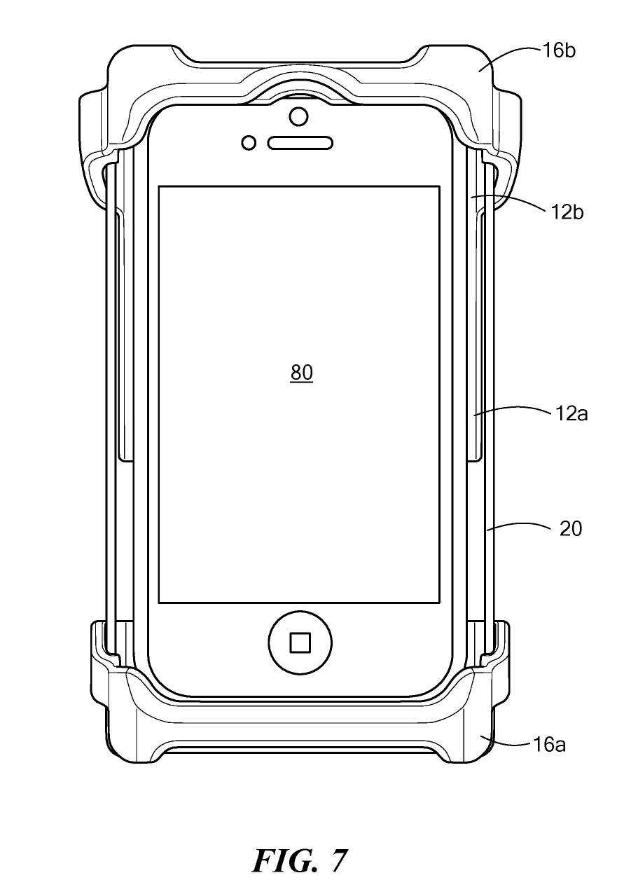

FIG. 7 shows cell phone 80 secured in place in the caddy between and partially within end cages 16a and 16b locked in this position via the locking mechanism and bungee cord 20. The result in this particular design is a new caddy which more securely retains an electronic device and yet is easy to use and enables the electronic device to be quickly and easily loaded into and removed from the caddy by releasing the locking mechanism and urging the two caddy tray portions away from each other. The caddy components can be molded and can be made of plastic materials.

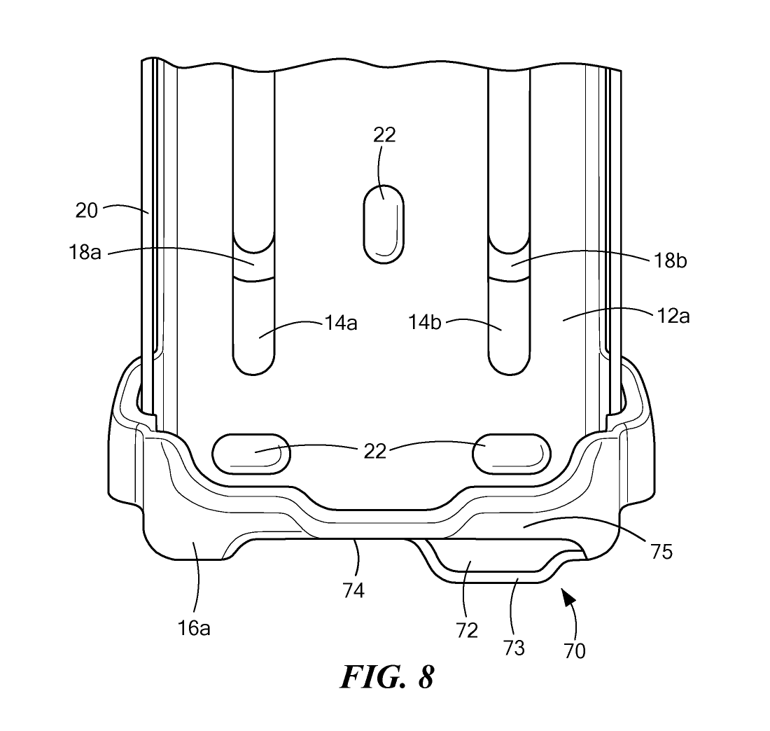

As shown in FIGS. 8-10, lower end cage 16a may include a passive sound amplifier 70. In one preferred design, amplifier 70 is a cup shaped member 72 located at the right lower end of the caddy (viewed from the front) for amplifying music, for example, from the iPhone speaker located (when viewed from the front) at the bottom right side of the iPhone.

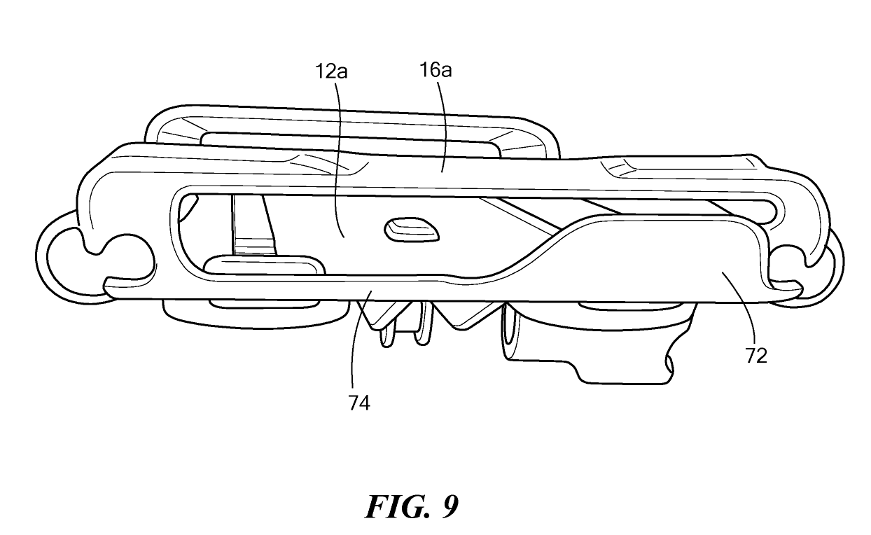

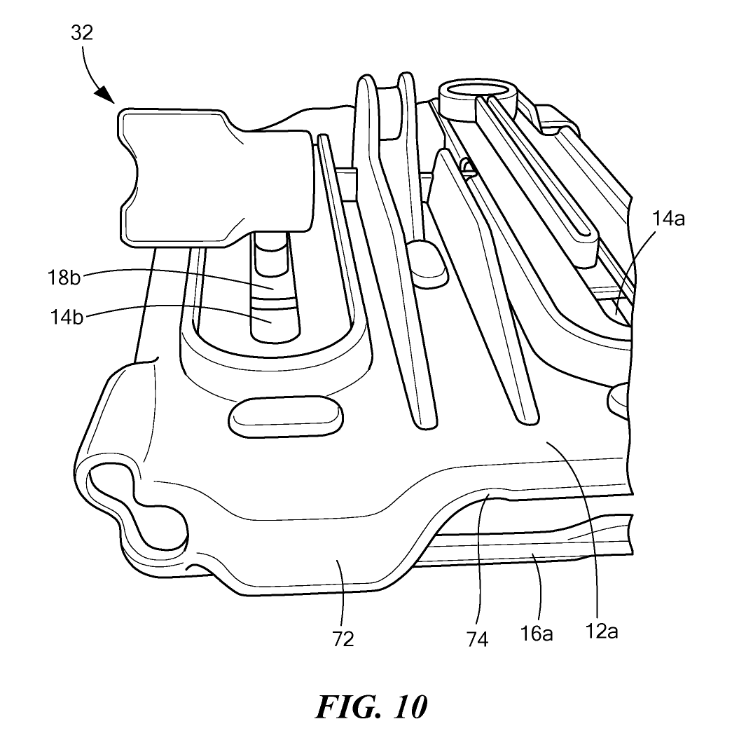

Cup member 72, FIGS. 9-10 may be integral with lower tray portion 12a and cup member 72 extends forward outwardly from the right side of the lower end 74 of the lower tray portion 12a. The front edge 73 of the cup member may extend to alignment with forward surface 75 of cage 16a.

The passive sound amplifier, in other embodiments, may have different shapes and/or may be located in different locations depending on the speaker(s) associated with electronic devices (e.g., smartphones) available from different manufacturers. Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. An electronic device caddy comprising:
a first tray portion with one or more lengthwise channels and an end cage;
a second tray portion including an end cage and one or more lengthwise rails each slideable in a channel of the first tray portion to load and accommodate different size electronic devices between the end cages;
a mounting bracket attached rearward of one said tray portion; and
a passive sound amplifier associated with an end cage.

2. The caddy of claim 1 further including a locking mechanism releaseably locking at least one rail in its channel

3. The caddy of claim 2 in which the locking mechanism includes a cam surface.

4. The caddy of claim 3 in which one rail includes a rearward ear extending out of a channel

5. The caddy of claim 4 in which the locking mechanism includes a ferrule with said cam surface, a slot in the ferrule receiving said ear, and a lever attached to the ferrule.

6. The caddy of claim 5 in which said cam surface engages said first tray portion frictionally urging said rail against an inside surface of the channel when the cam surface is rotated.

7. The caddy of claim 4 in which said channel includes a lengthwise rearward slot, said rail includes a lengthwise rearward ridge extending through said slot, and said ear extends rearwardly from said ridge.

8. The caddy of claim 1 in which said channels terminate proximate the end cage of the first tray portion.

9. The caddy of claim 1 in which said mounting bracket is configured as a handle bar mount.

10. The caddy of claim I further including one or more bungees urging said tray portions together.

11. The caddy of claim 10 in which there is a bungee extending from one cage to the other cage.

12. The caddy of claim 1 in which the passive sound amplifier is located on one side of said end cage.

13. The caddy of claim 1 in which said passive sound amplifier includes a cup member extending outwardly from a lower end of said first tray portion.

14. An electronic device caddy comprising:
an upper tray portion with an upper end cage;
a lower tray portion including a lower end cage, the upper and lower tray portions slideable with respect to each other to load and accommodate different size devices between the upper and lower end cages; and
the lower end cage including a passive sound amplifier.

15. The caddy of claim 14 further including a locking mechanism releasably locking the upper tray portion with respect to said lower tray portion.

16. The caddy of claim 15 in which one of the upper and lower tray portions include at least one rail and the other of the upper and lower tray portions include at least one channel slideably receiving said rail therein.

17. The caddy of claim 16 in which said locking mechanism includes a cam surface locking mechanism releaseably locking the rail in the channel, the locking mechanism connected to the rail through the first channel.

18. The caddy of claim 17 in which the rail includes a rearward ear.

19. The caddy of claim 18 in which the locking mechanism includes a ferrule with said cam surface and a slot therein receiving said ear.

20. The caddy of claim 19 in which the channel includes a lengthwise rearward slot, said first rail includes a lengthwise rearward ridge extending through said slot, and said ear extends rearwardly from said ridge.

21. The caddy of claim 14 further including one or more bungees urging said tray portions together.

22. The caddy of claim 21 in which there is a bungee extending from one cage to the other cage.

23. The caddy of claim 14 in which the passive sound amplifier is located on one side of said lower end cage.

24. The caddy of claim 14 in which said passive sound amplifier includes a cup member extending outwardly from a lower end of said lower tray portion.
